(19) United States
(12) Patent Application Publication
(10) Pub. No.: US 2006/0266566 A1
(43) Pub. Date: Nov. 30, 2006

(54) Vehicle

(76) Inventor: William David Steadman, Port Saint Lucie, FL (US)

Correspondence Address: SMITH-HILL AND BEDELL, P.C., 16100 NW CORNELL ROAD, SUITE 220, BEAVERTON, OR, 97006, US

(21) Appl. No.: 11/184,749

(22) Filed: Jul. 18, 2005

(30) Foreign Application Priority Data
May 28, 2005 (GB) 0510954.5

(51) Int. Cl. B60K 1/00

(52) U.S. Cl. 180/65.1

(57) ABSTRACT

A mobility scooter 10 with an openable rear part 40 which mounts a seat 52. The part 40 is movable between a closed position with the seat 52 facing forwards, and an inclined position with the seat 52 inclined outwardly to permit a person to get on or off the seat 52.

### BACKGROUND OF THE INVENTION

This invention concerns improvements in or relating to vehicles, and particularly but not exclusively mobility scooters.

The use of mobility scooters is increasing significantly. However, most such scooters are not provided with a cab or any protection, and are therefore not usable, or not pleasant to use, in inclement weather. Previously where cabs have been provided, this has usually resulted in a larger scooter being necessary than would otherwise be the case. As such scooters have generally been heavier, they have thus used more power. Also, it is not desirable for such scooters to be too big, as if this is the case they may be too large to be usable on pavements, where they are often required to be driven.

### SUMMARY OF THE INVENTION

According to the present invention there is provided a vehicle, the vehicle including a chassis, a seat for a driver of the vehicle, and a body mounted on the chassis, the body including a front part, a roof extending therefrom to a rear part, with a moving portion of the rear body part mounting the seat and being pivotally mounted relative to the remainder of the vehicle about a generally vertical axis towards the rear of the vehicle, such that the moving portion is movable between a closed position with the seat facing forwards, and an open position with the seat inclined outwardly to permit a person to get on or off the seat.

The vehicle may be in the form of a mobility scooter.

Preferably the pivotal mounting is substantially at the rear of the vehicle.

The pivotal mounting may be in the form of a hinge arrangement between the moving portion and the remainder of the rear body part. The hinge arrangement preferably extends substantially centrally up the rear body part.

The rear body part preferably also extends on each side of the vehicle part way towards the front of the vehicle. The rear body part preferably extends forwards to substantially adjacent the front of the seat.

The seat preferably includes a base part and a back part. The back part is preferably pivotally mounted to the base part. The seat may include a cushion assembly, which assembly may include a part which fits over the back part in a sleeve arrangement.

The vehicle preferably includes a rear storage area above which the seat locates in the closed position. The storage area preferably locates batteries for the vehicle, and preferably also provides storage space. The storage space may include a drawer located above the batteries, which drawer may be removable to permit access to the batteries. The storage area preferably includes side panels which can also be removed to permit access to the batteries.

A window or windows may be provided in the rear body part.

A catch may be provided for retaining the moving portion in the closed position, and the catch may be selectively engageable with the body roof.

Side curtains may be provided selectively extending from an upper part of the body.

Selectively releasable securing means are preferably provided between the front body part and the roof. The chassis may include selectively separable front and rear parts, with the front chassis part mounting the front body part, and the rear chassis part mounting the rear body part and roof.

The transmission and a motor for the vehicle are preferably mounted on a sub frame substantially between the rear wheels. The sub frame is preferably selectively removable from the rear chassis part to permit access to the transmission and motor.

The vehicle may also include a seat for a passenger and a second moving portion of the rear body part mounting the passenger seat and being pivotally mounted relative to the remainder of the scooter about a generally vertical axis towards the rear of the scooter, such that the second moving portion is movable between a closed position with the seat facing forwards, and an open position with the seat inclined outwardly in a opposite direction to the possible outward inclination of the driver seat to permit a person to get on or off the passenger seat.

### BRIEF DESCRIPTION OF THE DRAWINGS

An embodiment of the present invention will now be described by way of example only and with reference to the accompanying drawings, in which:

FIG. 1 is a diagrammatic front perspective view of a mobility scooter according to the invention in an open position;

FIG. 2 is a diagrammatic rear perspective view of the scooter of FIG. 1 in use in a closed position;

FIG. 3 is a diagrammatic front perspective view of part of the scooter of FIG. 1;

FIG. 4 is a diagrammatic rear perspective view of a further vehicle according to the invention in a closed position; and

FIG. 5 is a diagrammatic rear perspective view of part of the further vehicle of FIG. 4 in an open position.

### DETAILED DESCRIPTION

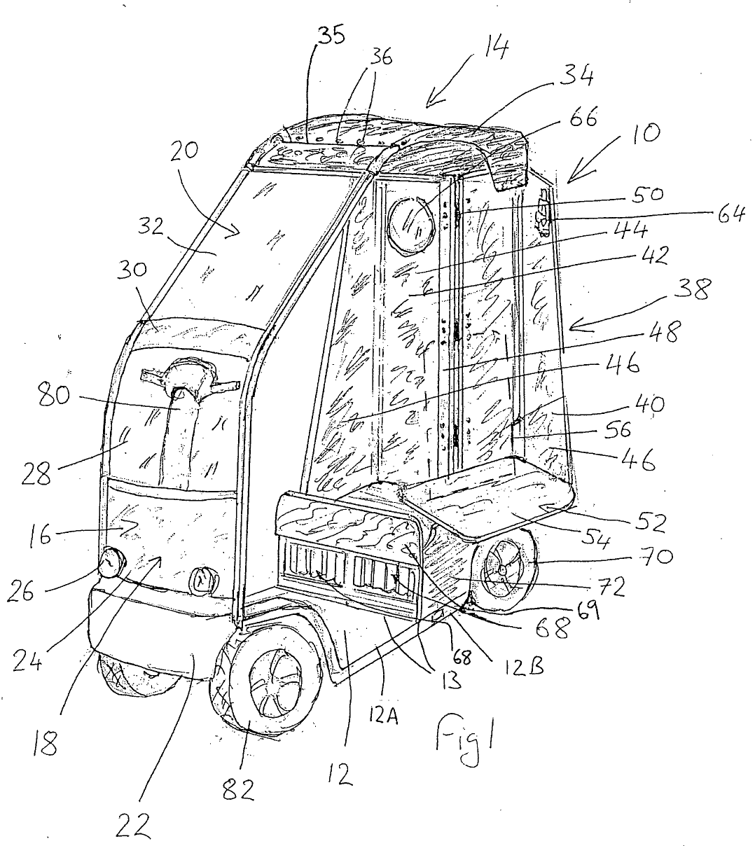

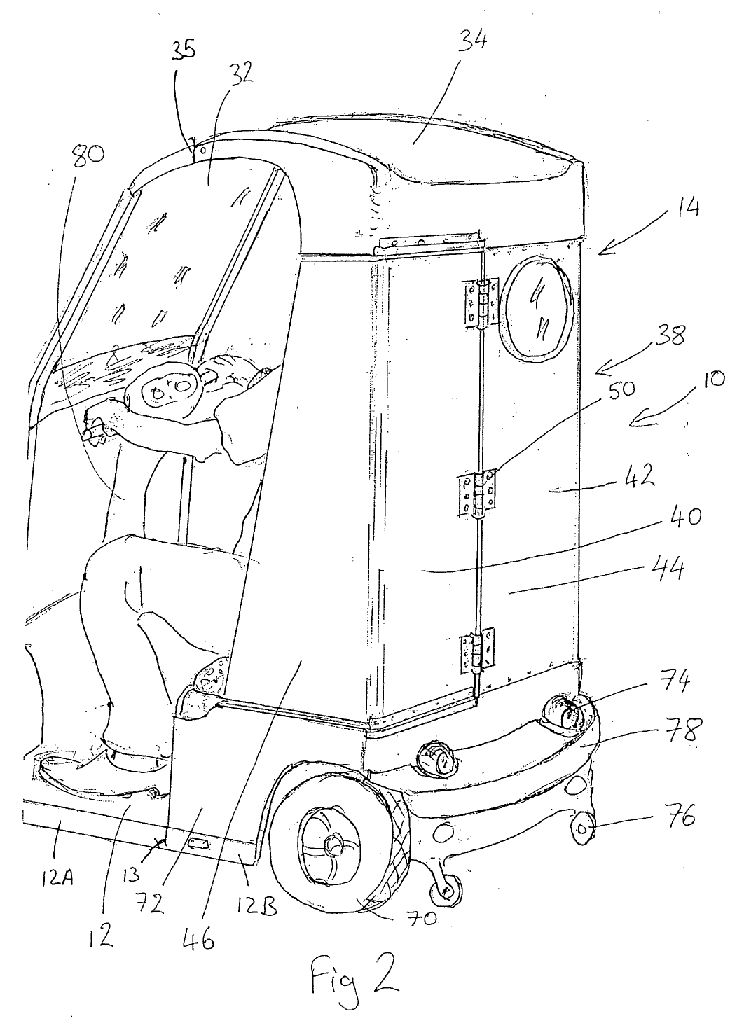

FIGS. 1 to 3 of the drawings show a mobility scooter 10 which can be driven in a conventional manner. The scooter 10 includes a chassis 12 with a body 14 mounted thereon. The chassis 12 comprises front and rear parts 12A, 12B, which can be selectively separated at 13. The parts 12A and 12B are connected by appropriate nuts and bolts (not shown).

The body 14 includes a front part 16 with a first lower part 18 which extends substantially vertically and an upper part 20 which is inclined rearwardly. The lower part 18 which extends above a bumper 22 on the chassis 12, has a bottom section 24 mounting two headlights 26. Provided thereabove is a first transparent part 28. The upper part 20 comprises a lower cross piece 30 with a second transparent part 32 thereabove.

The top of the upper part 20 joins to a roof 34 of the body 14 along a line 35, and is mounted thereto by a plurality of bolts 36 permitting separation if required along with separation of the front and rear chassis parts 12A and 12B, for major servicing or repair. The roof 34 extends gently convexly to a rear part 38. The rear part 38 is provided in two parts, an openable part 40 and a fixed part 42. The openable and fixed parts 40, 42 are generally similar with a vertical rear face 44 and side panels 46 which diverge downwardly. A central strut 48 is provided within the rear part 38, and the openable part 40 is pivotally mounted thereto by three hinges 50.

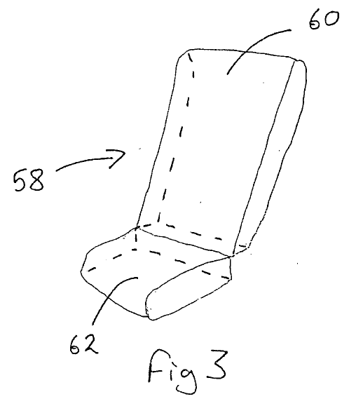

The openable part 40 mounts a seat 52 with a base part 54 and a back part 56 pivotally mounted thereto. In FIG. 1 the back part 56 has only been shown in shadow outline for clarity. A cushion assembly 58 (FIG. 3) is provided for the seat 52 with a back part 60 which fits over the seat back part 56 in the manner of a sleeve, and a cushioned base part 62 which fits on the seat base part 54 by virtue of fleece and hook fasteners (not visible).

A catch 64 is provided at an upper part of the openable part side panel 46 and is selectively engageable with the roof 34 to retain the openable part 40 in a closed position with the seat 52 facing forwards. Mounting pins or bolts (not shown) are provided on the lower edge of the rear part 38 to permit removal thereof from the chassis 12 if required for major servicing or repair. A circular window 66 is provided towards the top of the fixed part 42.

A rear storage area 68 is provided on the rear part 12B of the chassis 12 and in front of the rear wheels 70, but below the seat 52. The storage area locates batteries 68 for the scooter 10, and also provides a storage space in the form of a removable drawer 69 above the batteries 68. Side walls 72 are provided for the rear storage area, and the walls 72 can readily be removed again for servicing or repair. The motor and transmission for the scooter 10 are mounted on a sub frame (not visible) between the rear wheels 70, which sub frame can be removed if required from the chassis 12.

Rear lights 74 and jockey wheels 76 to prevent rearwards toppling of the scooter 10, are provided on the rear of the storage area 68, along with a bumper 78. Towards the front of the chassis 12 an adjustable steering column 80 is provided connected to the front wheels 82.

In use the openable part 40 can be pivotted outwardly as shown in FIG. 1 to readily permit a person to sit down thereon. The person can then rotate the seat 52 and hence openable part 42 such that the seat 52 faces forward, and the catch 64 will automatically close retaining the openable part 40 closed. The scooter 10 can then be driven in a usual manner whilst providing significant protection for a driver, and particularly from inclement weather. If required side curtains (not shown) may be provided extending from the roof 34 and perhaps also the upper part 20 of the front part 16 to provide extra protection, or at least protection when the scooter is not in use.

When a person wishes to alight the scooter 10, the catch 64 is released and the seat 52 and hence openable part 40 can be pivoted outwardly to the position shown in FIG. 1 to permit a person to readily leave the scooter.

There is thus described a scooter which provides for a number of advantages. Shelter from inclement weather is provided and with this design it is not necessary to provide overall larger dimensions for the scooter by virtue of the pivoting of the openable part with the seat, relative to conventional designs. With this arrangement it is not necessary to provide a substantial seat with strong armrests which is normally the case with such scooters, and in view of this there is little if any weight gain relative to existing scooters despite the provision of a cover for a driver. Significant storage area is provided beneath the seat, and a certain amount of storage will also be available behind the seat back. There would also be space for instance for a walking stick or frame on the inside of the non-openable side of the body.

The seating arrangement in the present scooter means it is not possible for a driver to lean backwards over the rear wheels which can occur on existing scooters, and thus improved stability is attained. The features that the body and chassis can be separated into two parts, the sub frame can be removed from the chassis, and the rear body part can be removed from the chassis, mean that major servicing, and repairs can readily be carried out. Therefore the scooter can readily be divided into two parts, with a front part comprising the front part of the chassis and the front part of the body, and a rear part comprising the rear part of the chassis, the roof, the body rear part, and the sub frame. Accordingly, in the case of damage, a front or rear part of the scooter could be temporarily or permanently replaced.

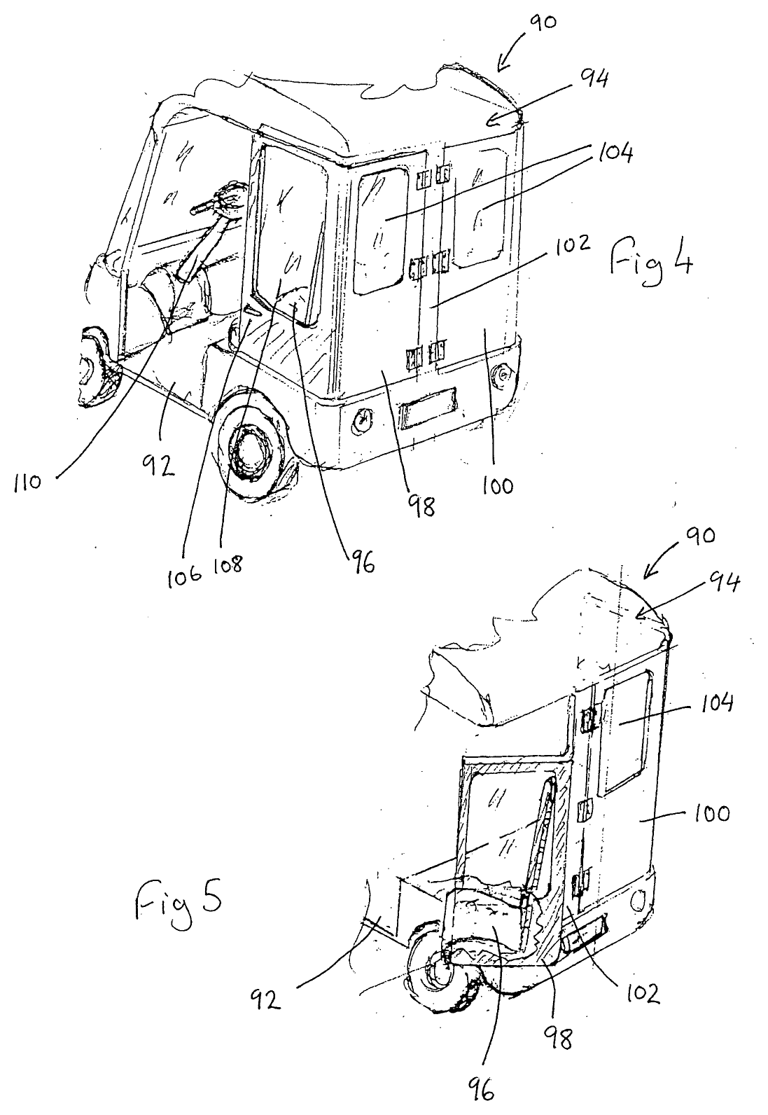

The invention could be used with other types of vehicles, and FIGS. 4 and 5 show a vehicle 90 suitable for instance for local use. The vehicle 90 is similar in many respects to the scooter 10, and therefore only the differences will be described in any detail. Again the vehicle 90 includes a chassis 92 with a body 94. In this instance the rear part of the body 94 mounts two seats with a driver seat 96, and a passenger seat which is not visible in the drawings.

The rear part of the body 94 comprises two openable parts 98, 100, with the first of these mounting the driver seat 96 and the other mounting the passenger seat. The openable parts 98, 100 are pivotably mounted to a central rear pillar 102. The openable parts 98, 100 can operate in a similar manner to the openable part 40 of the scooter 10, but with the passenger openable part 98 opening to the left of the vehicle 90 as shown in FIG. 5, and the openable part 100 being able to open on the right hand side of the vehicle.

In this instance the openable parts 98, 100 each include a rear window 104 and a full length side panel 106 with a window 108 therein. An adjustable steering column 110 is provided in front of the driver seat 96.

Various other modifications may be made without departing from the scope of the invention. For example, the openable part could be differently pivotally mounted. A different seat could be used. As indicated the invention could be used on other types of vehicles to mobility scooters.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A vehicle, the vehicle including a chassis, front and rear wheels, a seat for a driver of the vehicle, and a body mounted on the chassis, the body including a front part, a rear part, and a roof extending from the front part to the rear part, the rear body part having a moving portion which mounts the seat, pivotal mounting means being provided for mounting the moving portion relative to the remainder of the vehicle about a generally vertical axis towards the rear of the vehicle, such that the moving portion is movable between a closed position with the seat facing forwards, and an open position with the seat inclined outwardly to permit a person to get on or off the seat.

2. A vehicle in the form of a mobility scooter, the vehicle including a chassis, front and rear wheels, a seat for a driver of the vehicle, and a body mounted on the chassis, the body including a front part, a rear part, and a roof extending from the front part to the rear part, the rear body part having a moving portion which mounts the seat, pivotal mounting means being provided for mounting the moving portion relative to the remainder of the vehicle about a generally vertical axis towards the rear of the vehicle, such that the moving portion is movable between a closed position with the seat facing forwards, and an open position with the seat inclined outwardly to permit a person to get on or off the seat.

3. A vehicle according to claim 1, wherein the pivotal mounting is substantially at the rear of the vehicle.

4. A vehicle according to claim 1, wherein the pivotal mounting is in the form of a hinge arrangement between the moving portion and the remainder of the rear body part.

5. A vehicle according to claim 1, wherein the hinge arrangement extends substantially centrally up the rear body part.

6. A vehicle according to claim 1, wherein the rear body part extends on each side of the vehicle part way towards the front of the vehicle.

7. A vehicle according to claim 6, wherein the rear body part extends forwards to substantially adjacent the front of the seat.

8. A vehicle according to claim 1, wherein the seat includes a base part and a back part.

9. A vehicle according to claim 8, wherein means are provided for pivotally mounting the back part to the base part.

10. A vehicle according to claim 8, wherein the seat includes a cushion assembly with a part which fits over the back part in a sleeve arrangement.

11. A vehicle according to claim 1, wherein the vehicle includes a rear storage area above which the seat locates in the closed position.

12. A vehicle according to claim 11, wherein the storage area locates batteries for the vehicle, and also provides storage space.

13. A vehicle according to claim 12, wherein the storage space includes a drawer located above the batteries, which drawer is removable to permit access to the batteries.

14. A vehicle according to claim 11, wherein the storage area includes side panels which can be removed to permit access to the batteries.

15. A vehicle according to claim 1, wherein at least one window is provided in the rear body part.

16. A vehicle according to claim 1, wherein a catch is provided for retaining the moving portion in the closed position.

17. A vehicle according to claim 16, wherein the catch is selectively engageable with the body roof.

18. A vehicle according to claim 1, wherein side curtains are provided selectively extending from an upper part of the body.

19. A vehicle according to claim 1, wherein selectively releasable securing means are provided between the front body part and the roof.

20. A vehicle according to claim 1, wherein the chassis includes selectively separable front and rear parts, with the front chassis part mounting the front body part, and the rear chassis part mounting the rear body part and roof.

21. A vehicle according to claim 1, wherein the vehicle includes a sub frame, transmission and a motor, and the transmission and motor are mounted on the sub frame substantially between the rear wheels.

22. A vehicle according to claim 21, wherein the sub frame is selectively removable from the rear chassis part to permit access to the transmission and motor.

23. A vehicle according to claim 1, wherein the vehicle also includes a seat for a passenger and a second moving portion of the rear body part mounting the passenger seat, means being provided for pivotally mounting the second moving portion relative to the remainder of the scooter about a generally vertical axis towards the rear of the scooter, such that the second moving portion is movable between a closed position with the seat facing forwards, and an open position with the seat inclined outwardly in a opposite direction to the possible outward inclination of the driver seat to permit a person to get on or off the passenger seat.
